(19) United States
(12) Patent Application Publication
(10) Pub. No.: US 2013/0303230 A1
(43) Pub. Date: Nov. 14, 2013

(54) METHOD AND APPARATUS FOR AGGREGATED CQI FOR COORDINATED MULTIPOINT TRANSMISSION

(71) Applicant: SAMSUNG ELECTRONICS CO., LTD., Suwon-si (KR)

(72) Inventors: Krishna Sayana, San Jose, CA (US); Jianzhong Zhang, Plano, TX (US)

(73) Assignee: Samsung Electronics Co., LTD, Suwon-si (KR)

(21) Appl. No.: 13/888,617

(22) Filed: May 7, 2013

Related U.S. Application Data
(60) Provisional application No. 61/645,353, filed on May 10, 2012.

(51) Int. Cl. H04W 24/08

(52) U.S. Cl. CPC H04W 24/08
USPC 455/524

(57) ABSTRACT

In a Coordinated Multipoint (CoMP) wireless network comprising a plurality of transmission points (TPs), a user equipment (UE) performs a method of determining aggregated channel quality information (CQI). The method includes receiving signals corresponding to a joint transmission from the plurality of TPs in the CoMP network. The method also includes making an assumption about a transmission scheme of the joint transmission from the TPs. The method further includes determining aggregated CQI corresponding to the joint transmission based on the assumption about the transmission scheme. The method still further includes transmitting the aggregated CQI to the network.

### CROSS-REFERENCE TO RELATED APPLICATION(S) AND CLAIM OF PRIORITY

The present application is related to and claims priority under 35 U.S.C. §119(e) to U.S. Provisional Patent Application No. 61/645,353 filed May 10, 2012, entitled “Aggregated CQI For Coordinated Multipoint Transmission”. Provisional Patent Application No. 61/645,353 is assigned to the assignee of the present application and is hereby incorporated by reference into the present application as if fully set forth herein.

### TECHNICAL FIELD

The present application relates generally to wireless communication and, more specifically, to methods for determining aggregated channel quality indicators (CQI) in coordinated multipoint (CoMP) transmission.

### BACKGROUND

The field of mobile communication has witnessed a great revolution over the past two decades, with rapid development of new technologies to satisfy the ever increasing appetite for mobile communication applications and services. Examples of such technologies include CDMA 2000 1xEV-DO systems developed by 3GPP2, WCDMA, HSPA, and LTE systems developed by 3GPP, and mobile WiMAX systems developed by IEEE. Although the current wireless technologies, such as LTE/LTE-A, can provide data rates in the range of tens to hundreds of mega bits per second, their capacity may soon be exhausted by increasing demands for even higher data rates required by data-intensive applications such as video and music streaming. Furthermore, the number of subscribers to mobile communication services (already exceeding 5 billion), is expected to continue to grow rapidly.

### SUMMARY

For use at a user equipment (UE) in a Coordinated Multipoint (CoMP) wireless network comprising a plurality of transmission points (TPs), a method of determining aggregated channel quality information (CQI) is provided. The method includes receiving signals corresponding to a joint transmission from the plurality of TPs in the CoMP network. The method also includes making an assumption about a transmission scheme of the joint transmission from the TPs. The method further includes determining aggregated CQI corresponding to the joint transmission based on the assumption about the transmission scheme. The method still further includes transmitting the aggregated CQI to the network.

For use in a CoMP wireless network comprising a plurality of TPs, a UE configured to determine aggregated CQI is provided. The UE includes processing circuitry configured to receive signals corresponding to a joint transmission from the plurality of TPs in the CoMP network, make an assumption about a transmission scheme of the joint transmission from the TPs, determine aggregated CQI corresponding to the joint transmission based on the assumption about the transmission scheme, and transmit the aggregated CQI to the network.

For use in a CoMP wireless network, an eNodeB configured to control a plurality of TPs is provided. The eNodeB includes processing circuitry configured to coordinate a joint transmission from the plurality of TPs to a UE in communication with the plurality of TPs, and receive from the UE aggregated CQI corresponding to the joint transmission. The aggregated CQI is determined based on an assumption about a transmission scheme of the joint transmission.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless communication network, according to embodiments of this disclosure;

FIG. 2 illustrates a high-level diagram of a wireless transmit path according to an embodiment of this disclosure;

FIG. 3 illustrates a high-level diagram of a wireless receive path according to an embodiment of this disclosure;

FIGS. 4 through 6 illustrate different scenarios for coordinated multipoint (CoMP) transmissions;

FIG. 7 illustrates an approximation of joint transmission channel quality indicators and precoding matrix indicators, according to an embodiment of this disclosure;

FIG. 8 illustrates an example definition of aggregated CQI with fixed phase, according to an embodiment of this disclosure;

FIG. 9 illustrates an example definition of aggregated CQI with pre-determined phase cycling, according to an embodiment of this disclosure;

FIG. 10 illustrates an example definition of aggregated CQI with transmit diversity, according to an embodiment of this disclosure; and

FIG. 11 illustrates an example definition of aggregated CQI with TP cycling, according to an embodiment of this disclosure.

### DETAILED DESCRIPTION

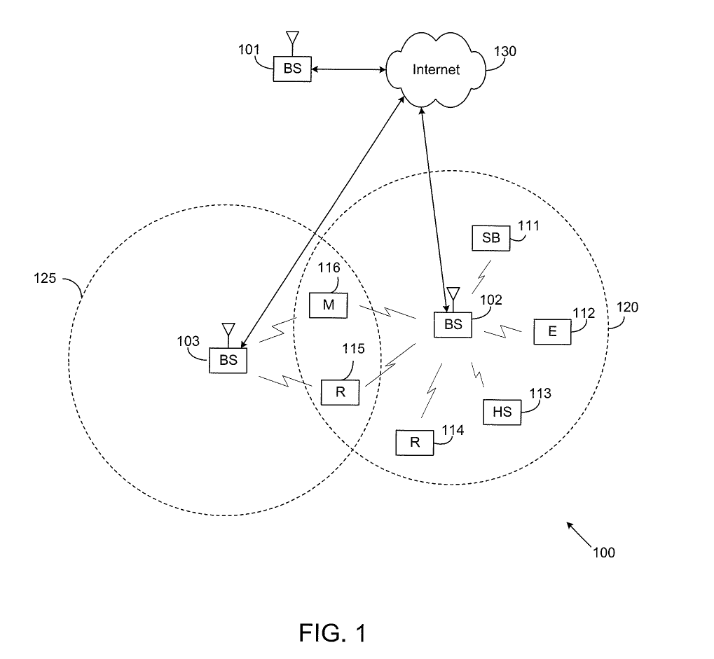

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The following documents and standards descriptions are hereby incorporated into the present disclosure as if fully set forth herein: (i) 3GPP TS 36.211 v10.1.0, “E-UTRA, Physical channels and modulation” (hereinafter “REF1”); (ii) 3GPP TS 36.212 v10.1.0, “E-UTRA, Multiplexing and Channel coding” (hereinafter “REF2”); (iii) 3GPP TS 36.213 v10.1.0, “E-UTRA, Physical Layer Procedures” (hereinafter “REF3”); (iv) RP-111365 Coordinated Multi-Point Operation for LTE WID (hereinafter “REF4”); and (v) 3GPP TR 36.819 v11.0.0, September 2011 (hereinafter “REF5”).

FIG. 1 illustrates a wireless network 100 according to one embodiment of this disclosure. The embodiment of wireless network 100 illustrated in FIG. 1 is for illustration only. Other embodiments of wireless network 100 could be used without departing from the scope of this disclosure.

The wireless network 100 includes eNodeB (eNB) 101, eNB 102, and eNB 103. The eNB 101 communicates with eNB 102 and eNB 103. The eNB 101 also communicates with Internet protocol (IP) network 130, such as the Internet, a proprietary IP network, or other data network.

Depending on the network type, other well-known terms may be used instead of “eNodeB,” such as “base station” or “access point”. For the sake of convenience, the term “eNodeB” shall be used herein to refer to the network infrastructure components that provide wireless access to remote terminals.

The eNB 102 provides wireless broadband access to network 130 to a first plurality of user equipments (UEs) within coverage area 120 of eNB 102. The first plurality of UEs includes UE 111, which may be located in a small business; UE 112, which may be located in an enterprise; UE 113, which may be located in a WiFi hotspot; UE 114, which may be located in a first residence; UE 115, which may be located in a second residence; and UE 116, which may be a mobile device, such as a cell phone, a wireless laptop, a wireless PDA, or the like. UEs 111-116 may be any wireless communication device, such as, but not limited to, a mobile phone, mobile PDA and any mobile station (MS).

For the sake of convenience, the term “user equipment” or “UE” is used herein to designate any remote wireless equipment that wirelessly accesses an eNB, whether the UE is a mobile device (e.g., cell phone) or is normally considered a stationary device (e.g., desktop personal computer, vending machine, etc.). In other systems, other well-known terms may be used instead of “user equipment”, such as “mobile station” (MS), “subscriber station” (SS), “remote terminal” (RT), “wireless terminal” (WT), and the like.

The eNB 103 provides wireless broadband access to a second plurality of UEs within coverage area 125 of eNB 103. The second plurality of UEs includes UE 115 and UE 116. In some embodiment, eNBs 101-103 may communicate with each other and with UEs 111-116 using LTE or LTE-A techniques.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Although FIG. 1 depicts one example of a wireless network 100, various changes may be made to FIG. 1. For example, another type of data network, such as a wired network, may be substituted for wireless network 100. In a wired network, network terminals may replace eNBs 101-103 and UEs 111-116. Wired connections may replace the wireless connections depicted in FIG. 1.

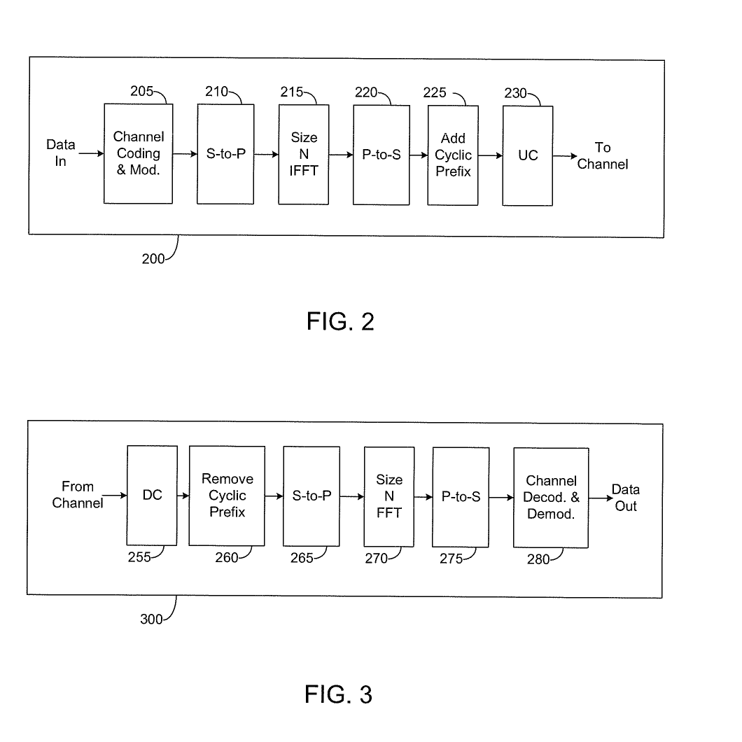

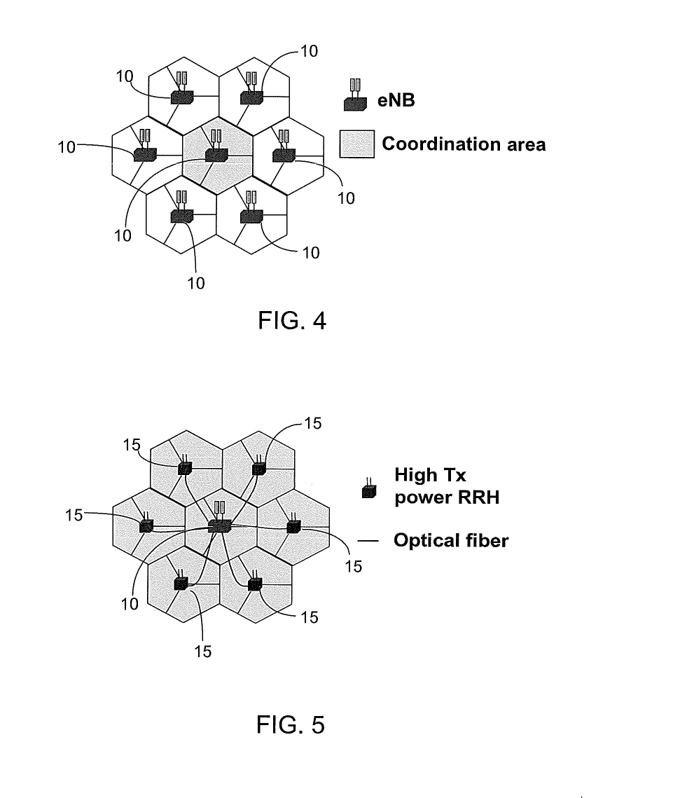

FIG. 2 is a high-level diagram of a wireless transmit path. FIG. 3 is a high-level diagram of a wireless receive path. In FIGS. 2 and 3, the transmit path 200 may be implemented, e.g., in eNB 102 and the receive path 300 may be implemented, e.g., in a UE, such as UE 116 of FIG. 1. It will be understood, however, that the receive path 300 could be implemented in an eNB (e.g. eNB 102 of FIG. 1) and the transmit path 200 could be implemented in a UE.

Transmit path 200 comprises channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230. Receive path 300 comprises down-converter (DC) 255, remove cyclic prefix block 260, serial-to-parallel (S-to-P) block 265, Size N Fast Fourier Transform (FFT) block 270, parallel-to-serial (P-to-S) block 275, channel decoding and demodulation block 280.

At least some of the components in FIGS. 2 and 3 may be implemented in software while other components may be implemented by configurable hardware (e.g., a processor) or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In transmit path 200, channel coding and modulation block 205 receives a set of information bits, applies coding (e.g., LDPC coding) and modulates (e.g., Quadrature Phase Shift Keying (QPSK) or Quadrature Amplitude Modulation (QAM)) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in eNB 102 and UE 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal may also be filtered at baseband before conversion to RF frequency.

The transmitted RF signal arrives at UE 116 after passing through the wireless channel and reverse operations to those at eNB 102 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

Each of eNBs 101-103 may implement a transmit path that is analogous to transmitting in the downlink to UEs 111-116 and may implement a receive path that is analogous to receiving in the uplink from UEs 111-116. Similarly, each one of UEs 111-116 may implement a transmit path corresponding to the architecture for transmitting in the uplink to eNBs 101-103 and may implement a receive path corresponding to the architecture for receiving in the downlink from eNBs 101-103.

3GPP has initiated a study on Coordinated Multi-Point (CoMP) transmission and reception techniques to facilitate cooperative communications across multiple transmission and reception points (e.g cells) for the LTE-Advanced system. In CoMP operation, multiple points coordinate with each other to improve signal quality to a user with interference avoidance and joint transmission techniques.

As used in this disclosure, CoMP transmission points (TPs) refer to transmitters associated with a CoMP transmission to a user equipment (UE) in a subframe. TPs may include remote radio heads (RRHs), macro eNodeBs, femto eNodeBs, pico eNodeBs, base stations, and the like. In some embodiments, CoMP TPs have different cell IDs. In other embodiments, CoMP TPs share the same cell IDs.

It is noted that two TPs participating in a CoMP transmission for a UE may transmit downlink signals either in the same component carrier, or in two different component carriers, wherein different component carriers may have different carrier frequencies. In the latter case, the UE may have been RRC configured with at least two component carriers: the primary cell and a secondary cell. Herein, the two terms “cell” and “component carrier” may be used interchangeably.

3GPP is currently standardizing the CoMP technology that allows the UE to receive signals from multiple transmission points (TPs) (see also REF4). REF5 defines four scenarios for CoMP transmissions, which will now be described.

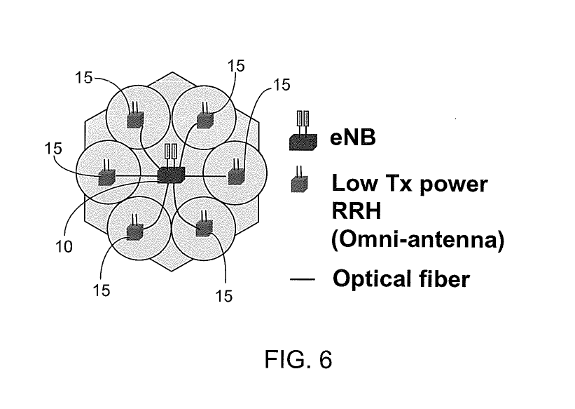

Scenario 1, illustrated in FIG. 4, is a homogeneous network comprising a number of eNodeBs 10 with intra-site CoMP.

Scenario 2, illustrated in FIG. 5, is a homogeneous network with a number of high transmission power RRHs 15. The central entity (e.g., an eNodeB) can coordinate nine (9) cells as a baseline, with the reference layout as in FIG. 5. In other embodiments, the central entity can coordinate three (3), nineteen (19), or twenty-one (21) cells.

Scenario 3, illustrated in FIG. 6, is a heterogeneous network with low power RRHs 15 within the macrocell coverage. In Scenario 3, the transmission/reception points created by the RRHs 15 have different cell IDs than the macro cell. The coordination area includes:
1 cell with N low-power nodes as a starting point; and
3 intra-site cells with 3*N low-power nodes.

Scenario 4, also illustrated in FIG. 6, is a heterogeneous network with low power RRHs 15 within the macrocell coverage where the transmission/reception points created by the RRHs have the same cell IDs as the macro cell. The coordination area includes:
1 cell with N low-power nodes as a starting point; and
3 intra-site cells with 3*N low-power nodes.

A CoMP transmission for a UE can be implemented differently depending on how CoMP transmission points share information. Two types of implementation include CoMP joint transmission with same data (CoMP-JTS) and CoMP joint transmission with different data (CoMP-JTD).

The CoMP schemes that have been identified as the focus for standardization are:
Joint transmission;
Dynamic point selection (DPS), including dynamic point blanking; and
Coordinated scheduling/beamforming, including dynamic point blanking.

With each hypothesis of different CoMP transmission schemes, the network may need to know the CQI supported by the UE to improve scheduling and choose the optimum CoMP schemes. The CQI definitions and measurements in the current specification are defined for a single-cell transmission. New CQI definitions may be needed to support multi-cell transmission.

The definition of CQI in the most recent version of LTE specification specifies a number of assumptions at UE for computing a CQI. These assumptions include:
The (single cell) transmission scheme assumed;
CSI Reference resource in time and frequency (e.g., frequency subband or subframe index);
Overhead due to reference signals or control channel transmission;
Power offset, i.e., ratio of physical downlink shared channel (PDSCH) RE power to Reference Signal RE power; and
Other parameters (Redundancy version for the code. e.g., RV0).

The transmission scheme assumed is based on the transmission mode the UE is configured with. This relationship is captured in Table 1 below, which is reproduced from Table 7.2.3-0 of REF3.

TABLE 1
PDSCH transmission scheme assumed for CSI reference resource

| Transmission mode | Transmission scheme of PDSCH |
|---|---|
| 1 | Single-antenna port, port 0 |
| 2 | Transmit diversity |
| 3 | Transmit diversity if the associated rank |
| | indicator is 1, otherwise large delay CDD |
| 4 | Closed-loop spatial multiplexing |
| 5 | Multi-user MIMO |
| 6 | Closed-loop spatial multiplexing with a |
| | single transmission layer |
| 7 | If the number of PBCH antenna ports is |
| | one, Single-antenna port, port 0; otherwise |
| | Transmit diversity |
| 8 | If the UE is configured without PMI/RI |
| | reporting: if the number of PBCH antenna |
| | ports is one, single-antenna port, port 0; |
| | otherwise transmit diversity |
| | If the UE is configured with PMI/RI |
| | reporting: closed-loop spatial multiplexing |
| 9 | If the UE is configured without PMI/RI |
| | reporting: if the number of PBCH antenna |
| | ports is one, single-antenna port, port 0; |
| | otherwise transmit diversity |
| | If the UE is configured with PMI/RI |
| | reporting: if the number of CSI-RS ports is |
| | one, single-antenna port, port 7; otherwise |
| | up to 8 layer transmission, ports 7-14 (see |
| | subclause 7.1.5B) |

With CQI feedback, the eNB is able to select a modulation and coding scheme (MCS) and, with a similar set of transmission conditions, can expect to achieve the performance (BLER target of 10%) as predicted by the UE. The encoding of the CQI index and corresponding MCS value is shown in Table 2 below, which is reproduced from Table 7.2.3-1 of REF3.

TABLE 2
4-bit CQI Table

| CQI index | modulation | code rate x 1024 | efficiency |
|---|---|---|---|
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

Further details of CQI are defined in Section 7.2.3 of REF3, which is incorporated herein.

The individual CoMP scheme performance is characterized by additional parameters, including:
The transmission points (TPs) used in the CoMP scheme;
Precoding applied at each of the one or more transmitting TPs;
The TPs that are blanked or not transmitting; and
The interference measurement resource that may be configured for measurement of individual CQIs.

CSI-RS Resource

In Release 10, a new type of reference signal, CSI-RS (channel state information—reference signal), is defined to enable channel measurements to a UE. Demodulation reference signals (DMRS) can be used for demodulation with transmission mode 9 introduced in Release 10.

A UE specific CSI-RS configuration includes (i) a non-zero power CSI-RS resource, and (ii) one or more zero-power CSI-RS resources. In a typical scenario, the antenna ports of a non-zero CSI-RS resource correspond to the antenna elements at the serving cell. The zero-power CSI-RS, also commonly referred to as muted CSI-RS, is used to protect the CSI-RS resources of another cell. A UE may rate match around these resources.

Further details of CSI reference signals are defined in Section 6.10.5 of REF1, which is incorporated herein.

To support CoMP transmission, a network may need feedback corresponding to multiple transmission points or cells. Thus, a network may set up multiple CSI-RS resources, each typically corresponding to a TP. Unless otherwise stated, the terms ‘CSI-RS resource’ and ‘TP’ are used interchangeably herein. Further details of CSI-RS resource configurations and the configurable parameters for each CSI-RS resource are shown below (based on recent developments in 3GPP):

CSI-RS (according to the agreement from RAN1#68bis)

Configuration of multiple non-zero-power CSI-RS resources includes at least:
AntennaPortsCount
ResourceConfig
SubframeConfig
P_{c}
Parameter X to derive scrambling initialization (X ranges from 0 to 503, and can be interpreted as a virtual cell id. In Rel-10, X is the PCI of the serving cell)

cᵢₙᵢₜ=2¹⁰·(7·(nₛ+1)+l+1)·(2·X+1)+2·X+N_{CP}

These parameters are configured per CSI-RS resource.

It is under discussion whether some parameters can be configured per CSI-RS port considering the decision of supporting coherent joint transmission by the aggregated CSI feedback corresponding to multiple TPs in one CSI-RS resource.

Aggregated CQI

Aggregated CQI refers to the CQI which corresponds to joint transmission to a UE from two or more transmission points. In this disclosure, methods will be described for defining aggregated CQI assuming different transmission schemes from the two CSI-RS resources.

Joint Transmission (JT)

Joint transmission broadly refers to simultaneous transmission of data to a UE from multiple co-operating TPs. The transmission may be coherent or non-coherent and aims to improve the overall system throughput. It is helpful to improve cell-edge performance by converting an interfering signal to a desired signal. In RRH deployments, a single BBU (an eNB) controlling multiple TPs can enable very low latency coordination among the TPs and allow joint scheduler implementations. Joint scheduling allows resource pooling, by dynamically adapting to short-term channel conditions and different traffic loads experienced across the control area of the BBU.

Coherent joint transmission may be based on spatial CSI feedback to two or more TPs, which can be used to perform MIMO transmissions from the corresponding aggregate set of antennas. However, better synchronization, good calibration, and much smaller timing error differences between transmission points may be needed to realize the full potential gains of coherent JT schemes.

To enable JT, the UE reports a precoding matrix indicator (PMI) and corresponding Channel Quality Indicator (CQI) with the assumption of joint transmission from a set of aggregate antennas corresponding to the JT TPs. The TPs assumed for JT may be set up semi-statically by the network. More flexibility can be achieved at the scheduler if the UE feeds back PMI/CQI corresponding to a multiple JT transmission hypothesis.

In an example CoMP network including two TPs participating in the CoMP transmissions, the eNB may dynamically switch between the following transmission schemes: (i) transmission from TP1; (ii) transmission from TP2; and (iii) joint transmission from TP1 and TP2

The simplest approach is to allow feedback for all the above transmission schemes (or hypotheses). However, there is a trade-off of flexibility and overhead. In one method, the codebooks can be designed with a hierarchical approach. The PMI/CQI for the individual TPs are first selected assuming single TP transmission, according to the following:

r₁=H₁W₁s+n

where r₁ is the received signal vector at the UE, H₁ is the NrxNt channel from TP1 to the UE, W₁ is the Ntx υ precoder, s is the τ×1 symbol vector corresponding to a spatial transmission with υ layers (rank=υ), and n is the noise component at the receiver. The PMI W₁ and rank are computed based on channel H₁ at the UE.

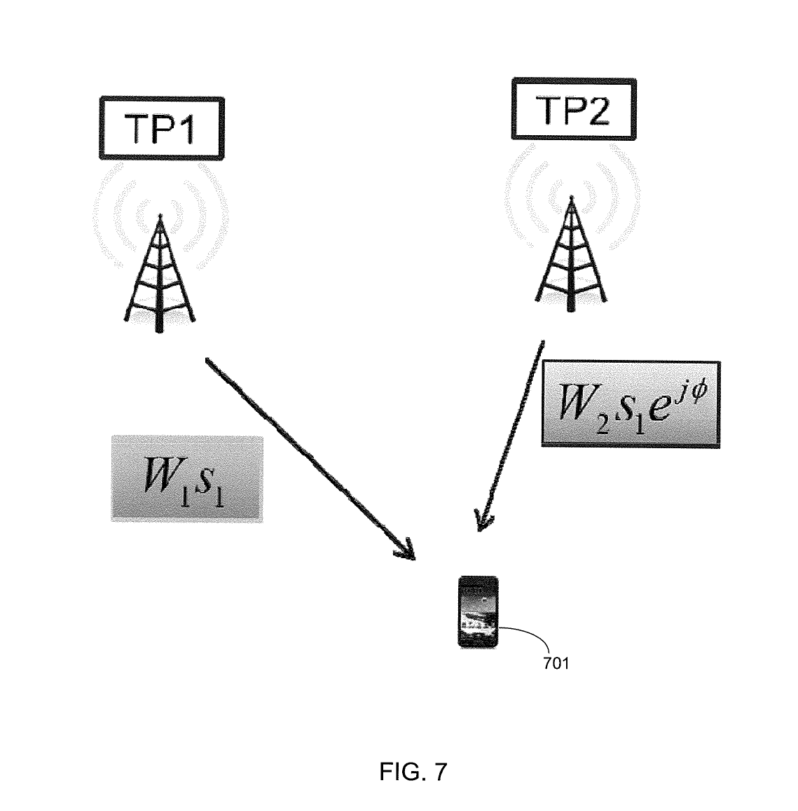

For multi-TP joint transmission, JT-CQI and JT-PMI can be approximated by concatenating each TP's PMI with inter-TP co-phasing information, also referred to as inter-TP phase feedback α=e^{jφ}. This is illustrated in the FIG. 7.

The signal model at the UE receiver 701 in FIG. 7 can be expressed as:

$$\begin{matrix}{r}_{JT} = {H}_{1} {W}_{1} s + {H}_{2} {W}_{2} s {e}^{j φ} \\ = [ {\begin{matrix}{H}_{1} & H\end{matrix}}_{2} ] [ \begin{matrix}{W}_{1} \\ {W}_{2} {e}^{j φ}\end{matrix} ] s + n .\end{matrix}$$

So the PMI for joint transmission is constrained to be of the form

$$[ \begin{matrix}{W}_{1} \\ α {W}_{2}\end{matrix} ] = [ \begin{matrix}{W}_{1} \\ {W}_{2} {e}^{j φ}\end{matrix} ]$$

to save overhead by avoiding transmission of an additional aggregate PMI (of dimension 2Ntxυ).

Accuracy of Inter-TP Phase Feedback

If the TPs are well calibrated and synchronized, then the inter-TP phase component required for coherent combining measured by the UE can be effectively used by the network. On the other hand, if the inter-TP phase at the network is not readily trackable (i.e., if the phase changes frequently in frequency and time), then the feedback of the inter-TP phase information may not be very useful to the network. In this case, it may be better for the network to use an open loop type of scheme for combining the signal from two TPs without the feedback of the inter-TP phase information.

Aggregated CQI for Joint Transmission

While performing joint transmission, the network may need to predict the MCS for joint transmission based on CQI feedback. There are several options to enable the appropriate aggregated CQI feedback, as described below.

Per-TP (or per CSI-RS resource) CQI feedback only: With this option, the UE feeds back the CQI for TP1 and TP2 individually and does not request additional aggregated CQI feedback for joint transmission. In this option, it is assumed that the network can construct the CQI for joint transmission with some approximation based on per-TP CQIs.

Aggregated CQI Feedback with inter-TP Phase: If the UE is requested to feed back inter-TP phase, then the definition of aggregated CQI for joint transmission is straightforward. The UE determines the JT precoder

$$[ \begin{matrix}{W}_{1} \\ {W}_{2} {e}^{j φ}\end{matrix} ]$$

including the phase component to maximize the rate, and computes the CQI with this precoder.

Aggregated CQI Feedback without inter-TP (or inter-CSI-RS resource) phase feedback: In this option, the assumption at the UE may need to be clearly defined, since no associated phase is fed back. Several options are described below.

Aggregated CQI with Fixed Phase

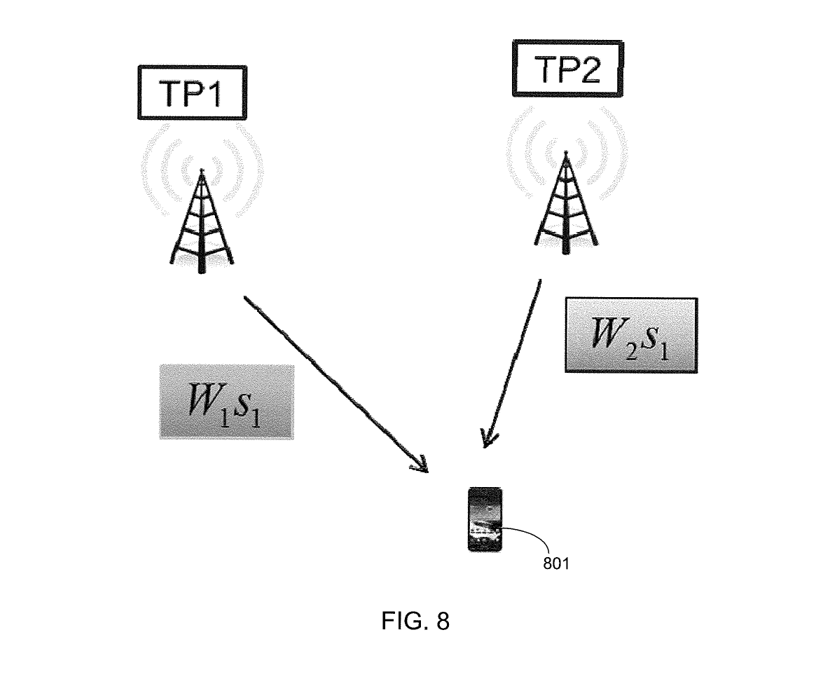

FIG. 8 illustrates an example definition of aggregated CQI with fixed phase, according to an embodiment of this disclosure. The embodiment illustrated in FIG. 8 is for illustration only. Other embodiments could be used without departing from the scope of this disclosure.

In FIG. 8, the CQI definition is based on a predefined and fixed phase reference. The signal model at the UE receiver 801 can be expressed as:

$$\begin{matrix}{Y}_{JT} = {H}_{1} {W}_{1} s + {H}_{2} {W}_{2} s \\ = [ \begin{matrix}{H}_{1} & {H}_{2}\end{matrix} ] [ \begin{matrix}{W}_{1} \\ {W}_{2}\end{matrix} ] s + n\end{matrix}$$

where a fixed phase of φ=0 is used. In general any fixed phase may be used.

There are some limitations to this method since the fixed phase may be not be optimal, resulting in a very low or very high CQI (assuming the eNB also uses the same fixed phase for transmission). This can be improved if the following three conditions are met: (i) CQI definition is over a large enough bandwidth (e.g., wideband); (ii) eNB data allocation is also over a large number of subbands; and (iii) the optimal phase for combining varies significantly over the bands. In this case, some of the CQI errors are averaged leading to acceptable performance.

In an embodiment, new CQI definitions include per-CSI-RS resource CQI, aggregated CQI with inter-TP phase, and aggregated CQI with fixed phase.

In the CSI reference resource, the UE makes a number of assumptions for the purpose of deriving the CQI index, and if also configured, PMI and RI. The assumptions include:
The first 3 OFDM symbols are occupied by control signaling;
No resource elements used by primary or secondary synchronization signals or PBCH;
CP length of the non-MBSFN subframes;
Redundancy Version 0; and
If CSI-RS is used for channel measurements, the ratio of PDSCH EPRE to CSI-RS EPRE is as given in Section 7.2.5 of REF3.

For transmission mode 9 CSI reporting, CRS REs are as in non-MBSFN subframes. If the UE is configured for PMI/RI reporting, the UE-specific reference signal overhead is consistent with the most recent reported rank. The PDSCH signals on antenna ports {7 . . . 6+υ} for υ layers result in signals equivalent to corresponding symbols transmitted on antenna ports {15 . . . 14+P}, as given by:

$$[ \begin{matrix}{y}^{( 15 )} ( i ) \\ ⋮ \\ {y}^{( 14 + P )} ( i )\end{matrix} ] = W ( i ) [ \begin{matrix}{x}^{( 0 )} ( i ) \\ ⋮ \\ {x}^{( υ - 1 )} ( i )\end{matrix} ] .$$

where x(i)=[x⁽⁰⁾(i) . . . x^{(υ-1)}(i)]^{T} (Or is a vector of symbols from the layer mapping in section 6.3.3.2 of REF1, Pε{1,2,4,8} is the number of CSI-RS ports configured, and if only one CSI-RS port is configured, W(i) is 1, otherwise W(i) is the precoding matrix corresponding to the reported PMI applicable to x(i). The corresponding PDSCH signals transmitted on antenna ports {15 . . . 14+P} have a ratio of EPRE to CSI-RS EPRE equal to the ratio given in section 7.2.5 of REF3.

For transmission mode X CSI reporting, CRS REs are as in non-MBSFN subframes. For CQI based on a single CSI-RS resource, if the UE is configured for PMI/RI reporting, the UE-specific reference signal overhead is consistent with the most recent reported rank on the CSI-RS resource. The PDSCH signals on antenna ports {7 . . . 6+υ} for υ layers result in signals equivalent to corresponding symbols transmitted on antenna ports {a₁, a₂, . . . a_{P}} of the CSI-RS resource, as given by:

$$[ \begin{matrix}{y}^{a 1} \\ ⋮ \\ ⋮ \\ {y}^{aP}\end{matrix} ] = W ( i ) [ \begin{matrix}{x}^{( 0 )} ( i ) \\ ⋮ \\ ⋮ \\ {x}^{( υ - 1 )} ( i )\end{matrix} ] ,$$

where x(i)=[x⁽⁰⁾(i) . . . x^{(ν-1)}(i)]^{T} is a vector of symbols from the layer mapping in section 6.3.3.2 of REF1, Pε{1,2,4,8} is the number of CSI-RS ports configured for the CSI-RS resource, and if only one CSI-RS port is configured for the CSI-RS resource, W(i) is 1, otherwise W(i) is the precoding matrix corresponding to the reported PMI for the CSI-RS resource applicable to x(i). The corresponding PDSCH signals transmitted on antenna ports {a₁, a₂, . . . a_{P}} have a ratio of EPRE to CSI-RS EPRE equal to the ratio given in section 7.2.5 of REF3.

For aggregated CQI based on two CSI-RS resources, i.e., a first and a second CSI-RS resource with precoding, if the UE is configured for PMI/RI reporting, the UE-specific reference signal overhead is consistent with the most recent reported rank. The PDSCH signals on antenna ports {7 . . . 6+υ} for υ layers result in signals equivalent to corresponding symbols transmitted on antenna ports {a₁, a₂, . . . a_{P}} of the first CSI-RS resource as given by:

$$[ \begin{matrix}{y}^{a 1} \\ ⋮ \\ ⋮ \\ {y}^{aP}\end{matrix} ] = {W}_{1} ( i ) [ \begin{matrix}{x}^{( 0 )} ( i ) \\ ⋮ \\ ⋮ \\ {x}^{( υ - 1 )} ( i )\end{matrix} ] ,$$

and result in signals transmitted on antennas ports {b₁, b₂, . . . b_{Q}} of the second CSI-RS resource as given by:

$$[ \begin{matrix}{y}^{b 1} \\ ⋮ \\ ⋮ \\ {y}^{bQ}\end{matrix} ] = α {W}_{2} ( i ) [ \begin{matrix}{x}^{( 0 )} ( i ) \\ ⋮ \\ ⋮ \\ {x}^{( υ - 1 )} ( i )\end{matrix} ] ,$$

where x(i)=[x⁽⁰⁾(i) . . . x^{(υ-1)}(i)]^{T} is a vector of symbols from the layer mapping in section 6.3.3.2 of REF1, and P, Qε{1,2,4,8} are the number of CSI-RS ports configured for the first and second CSI-RS resources respectively. If only one CSI-RS port is configured for the first CSI-RS resource, W₁(i) is 1, otherwise W₁(i) is the precoding matrix corresponding to the reported PMI applicable to the first CSI-RS resource. If only one CSI-RS port is configured for the second CSI-RS resource, W₂(i) is 1, otherwise W₂(i) is the precoding matrix corresponding to the reported PMI applicable to the second CSI-RS resource. For aggregated CQI based on an inter-CSI-RS phase feedback, α is the inter-CSI-RS phase feedback (α=e^{jφ} and could be based on a PSK (phase shift keying) constellation). Otherwise α=1. The corresponding PDSCH signals transmitted on antenna ports {a₁, a₂, . . . a_{P}} and {b₁, b₂, . . . b_{Q}} have a ratio of EPRE to CSI-RS EPRE configured for the corresponding CSI-RS resource (i.e., the configured value of P_{C}, the assumed ratio of PDSCH EPRE to CSI-RS EPRE for the corresponding CSI-RS resource).

In the CSI reference resource, the UE also assumes no REs allocated for CSI-RS and zero-power CSI-RS, and assumes no REs allocated for PRS. The PDSCH transmission scheme is given by Table 7.2.3-0 of REF3, depending on the transmission mode currently configured for the UE (which may be the default mode).

Aggregated CQI with Pre-Determined Phase Cycling

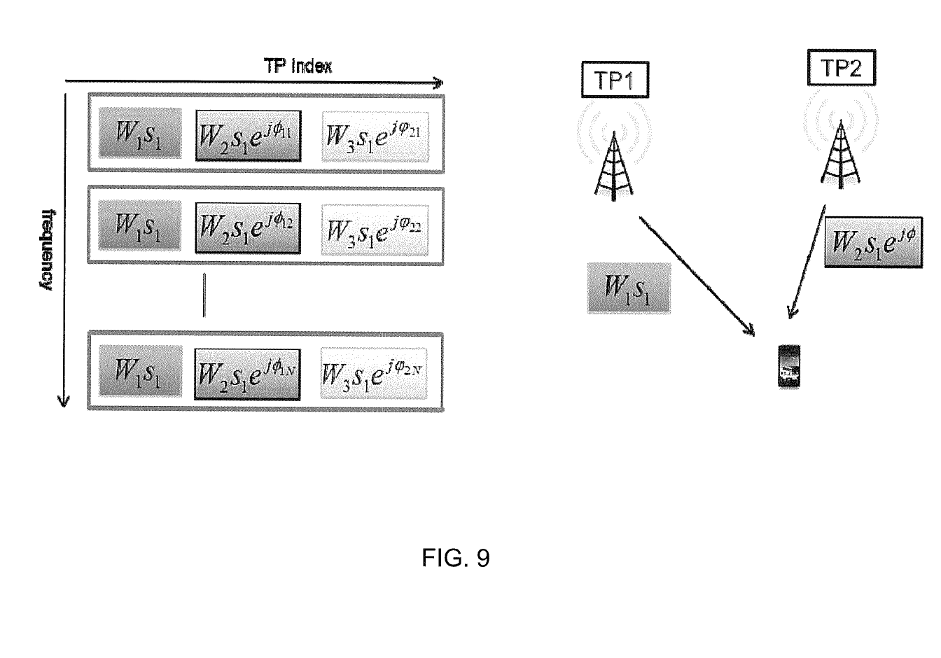

FIG. 9 illustrates an example definition of aggregated CQI with pre-determined phase cycling, according to an embodiment of this disclosure. The embodiment illustrated in FIG. 9 is for illustration only. Other embodiments could be used without departing from the scope of this disclosure.

In FIG. 9, the aggregated CQI is defined based on a deterministic/pre-defined cycling of the phase. In this embodiment, the aggregated CQI definition assumes a different pre-defined phase value depending on the frequency (e.g., subband or resource block (RB) in frequency). The dependency is based on a pre-defined relationship or mapping between inter-TP phases and subbands. The relationship is predetermined and known at the UE. With the wideband CQI, the above definition is effective if the following two conditions are met: (i) CQI definition is over a large enough bandwidth (e.g., a whole bandwidth); and (ii) eNB data allocation is also distributed over a large number of subbands.

However, if the optimal phase is not frequency selective, this definition works better than using a fixed phase. For CQI assumptions, the transmitted signal on the antenna ports of both CSI-RS resources can be represented as follows:

$$[ \begin{matrix}{y}^{( {a}_{1} )} ( i ) \\ ⋮ \\ {y}^{( {a}_{P} )} ( i ) \\ {y}^{( {b}_{1} )} ( i ) \\ ⋮ \\ {y}^{( {b}_{P} )} ( i )\end{matrix} ] = [ \begin{matrix}{W}_{1} ( i ) & 0 \\ 0 & {W}_{2} ( i )\end{matrix} ] [ \begin{matrix}{1}_{υ x 1} \\ {α}_{υ x 1} ( i )\end{matrix} ] [ \begin{matrix}{x}^{( 0 )} ( i ) \\ ⋮ \\ {x}^{( υ - 1 )} ( i )\end{matrix} ]$$

where 1_{υx1}=[1 1 . . . 1]^{T} and α_{υx1}(i) is a co-phasing vector.

In one method α_{υx1}(i)=α(i)1_{υx1}, where single co-phasing value is used for all layers. In another method, α_{υx1}(i)=[α₀ . . . α_{υ-1}], where different co-phasing values are used for each layer. In yet another method, α_{υx1}(i) is fixed for all subcarriers i within a RB, but cycled across RBs.

Aggregated CQI with Wideband Phase Feedback

In an embodiment, when it can be assumed that the phase is trackable in time, some feedback of phase information may be useful.

In one method, aggregated CQI is defined based on wideband phase feedback. The wideband phase α^{wb}, which is constant over the whole bandwidth, is derived at the UE assuming a wideband allocation (constituting two or more subbands) to maximize a wideband aggregated CQI.

The signal transmitted on the antenna ports is expressed by:

$$[ \begin{matrix}{y}^{( {a}_{1} )} ( i ) \\ ⋮ \\ {y}^{( {a}_{P} )} ( i ) \\ {y}^{( {b}_{1} )} ( i ) \\ ⋮ \\ {y}^{( {b}_{P} )} ( i )\end{matrix} ] = [ \begin{matrix}{W}_{1} ( i ) & 0 \\ 0 & {W}_{2} ( i )\end{matrix} ] [ \begin{matrix}{1}_{υ x 1} \\ {α}_{υ x 1}^{wb}\end{matrix} ] [ \begin{matrix}{x}^{( 0 )} ( i ) \\ ⋮ \\ {x}^{( υ - 1 )} ( i )\end{matrix} ] .$$

In one method, the aggregated CQI on each sub-band is defined assuming the wideband phase α^{wb}. The feedback can include the following elements.

Feedback Elements with Wideband Inter-TP phase
Wideband per-TP PMIs
Wideband inter-TP phase
Wideband aggregated CQI based on Wideband inter-TP phase
Subband per-TP PMIs for one or more subbands
Subband aggregated CQI based on the corresponding Subband PMIs and
Wideband aggregate inter-TP phase

Wideband inter-TP phase may be preferred in some embodiments due to following reasons: (i) minimal overhead; (ii) if the optimal phase for combining is fixed over the bandwidth, it is captured by the UE optimally; (iii) if the optimal phase for combining varies over the bandwidth significantly, then it performs similar to the definition with random phase with lower UE complexity for implementation; and (iv) subband aggregated CQI definition is improved, since a wideband phase reference is fed back and is likely to have lower mismatch than a fixed phase or a random phase.

Aggregated CQI with Transmit Diversity

The above schemes rely on incoherent combining, which may result in some bottleneck for smaller bandwidth allocations and, in general, may not be the best open loop scheme for joint transmission when the phase is rapidly changing in time as well. In such a case, transmit diversity based on precoded channels at each TP can be used for non-coherent combining of the transmitted signals.

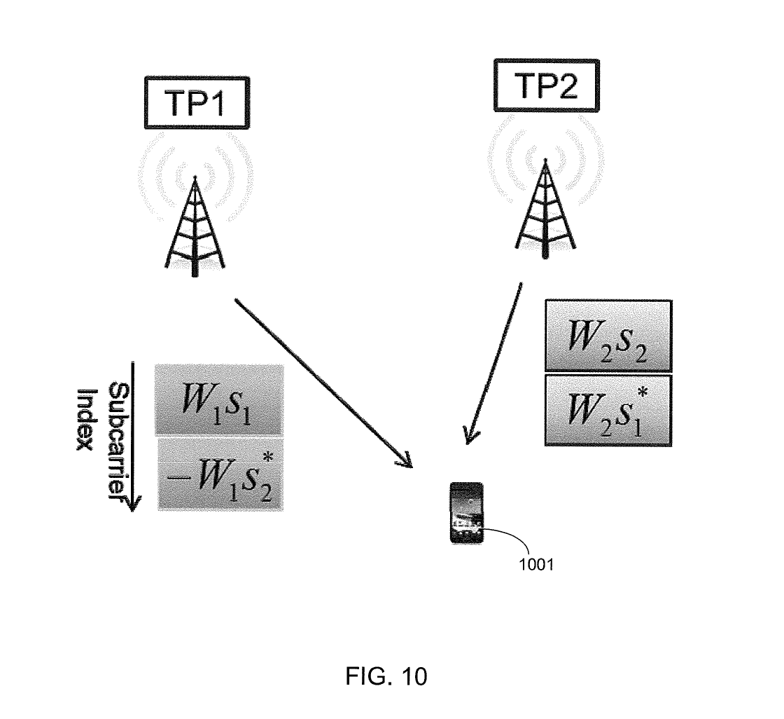

FIG. 10 illustrates an example definition of aggregated CQI with transmit diversity, according to an embodiment of this disclosure. The embodiment illustrated in FIG. 10 is for illustration only. Other embodiments could be used without departing from the scope of this disclosure.

In FIG. 10, the hypothetical transmission scheme for the aggregated CQI definition is based on transmit diversity of the precoded virtual channels from each TP. In one method, for joint rank 1 transmission, a modification of a known STBC Alamouti scheme is used based on per-TP precoded channels H₁W₁ and H₂W₂, from TP1 and TP2 respectively. The received signals at the UE receiver 1001 can be expressed as:

r₁=(H₁W₁)s₁−(H₂W₂)s₂+n₁

r₂=−(H₁W₁)s₂*+(H₂W₂)s₁*+n₂

where r₁ and r₂ are the received signals in two frequency (or time with STBC) resources (resource elements or REs in LTE). The channels are assumed to be approximately the same on both REs. Symbols s₁ and s₂ are the two modulated symbols transmitted over two frequency/time resources.

In this method, the UE computes aggregated CQI based on the following steps.

1) Derive PMI F1 for TP1 based on channel measurement H1 to TP1.

2) Derive PMI F2 for TP2 based on channel measurement H2 to TP2.

3) Derive equivalent channels H1F1 and H2F2

4) Derive aggregated CQI assuming Alamouti transmit diversity scheme using the two equivalent channels H1F1 and H2F2.

The current transmit diversity transmission scheme from Section 6.3.4.3 of REF1 is reproduced below, followed by the new definition for transmit diversity based on two CSI-RS resources, according to embodiments of this disclosure.

6.3.4.3 Precoding for Transmit Diversity

Precoding for transmit diversity is only used in combination with layer mapping for transmit diversity as described in Section 6.3.3.3. The precoding operation for transmit diversity is defined for two and four antenna ports.

For transmission on two antenna ports, pε{0,1}, the output y(i)=[y⁽⁰⁾(i) y⁽¹⁾(i)]^{T}, i=0, 1, . . . , M_{symb}^{ap}−1 of the precoding operation is defined by

$$[ \begin{matrix}{y}^{( 0 )} ( 2 i ) \\ {y}^{( 1 )} ( 2 i ) \\ {y}^{( 0 )} ( 2 i + 1 ) \\ {y}^{( 1 )} ( 2 i + 1 )\end{matrix} ] = \frac{1}{\sqrt{2}} [ \begin{matrix}1 & 0 & j & 0 \\ 0 & - 1 & 0 & j \\ 0 & 1 & 0 & j \\ 1 & 0 & - j & 0\end{matrix} ] [ \begin{matrix}Re ( {x}^{( 0 )} ( i ) ) \\ Re ( {x}^{( 1 )} ( i ) ) \\ Im ( {x}^{( 0 )} ( i ) ) \\ Im ( {x}^{( 1 )} ( i ) )\end{matrix} ]$$

for i=0, 1, . . . , M_{symb}^{layer}−1 with M_{symb}^{ap}=2M_{symb}^{layer}.

Definition of Precoding for Transmit Diversity based on two CSI-RS resources.

For transmission from antenna ports (a₁, a₂, . . . a_{P}) and (b₁, b₂, . . . b_{Q}) corresponding to a first and a second CSI-RS resource respectively, the output y(i)=[y^{(a1)}(i) y^{(aP)}(i), y^{(b1)}(i) . . . y^{(bQ)}(i)]^{T}, i=0, 1, . . . , M_{symb}^{ap}−1 of the precoding operation on the two CSI-RS resources is defined by:

$$[ \begin{matrix}{y}^{( a 1 )} ( 2 i ) \\ ⋮ \\ {y}^{( aP )} ( 2 i ) \\ {y}^{( a 1 )} ( 2 i + 1 ) \\ ⋮ \\ {y}^{( a 1 )} ( 2 i + 1 )\end{matrix} ] = [ \begin{matrix}{W}_{1} ( i ) & 0 & j {W}_{1} ( i ) & 0 \\ 0 & {W}_{1} ( i ) & 0 & j {W}_{1} ( i )\end{matrix} ] [ \begin{matrix}Re ( {x}^{( 0 )} ( i ) ) \\ Re ( {x}^{( 1 )} ( i ) ) \\ Im ( {x}^{( 0 )} ( i ) ) \\ Im ( {x}^{( 1 )} ( i ) )\end{matrix} ] \\ [ \begin{matrix}{y}^{( b 1 )} ( 2 i ) \\ ⋮ \\ {y}^{( bQ )} ( 2 i ) \\ {y}^{( b 1 )} ( 2 i + 1 ) \\ ⋮ \\ {y}^{( b Q )} ( 2 i + 1 )\end{matrix} ] = [ \begin{matrix}0 & {W}_{2} ( i ) & 0 & j {W}_{2} ( i ) \\ {W}_{2} ( i ) & 0 & - j {W}_{2} ( i ) & 0\end{matrix} ] [ \begin{matrix}Re ( {x}^{( 0 )} ( i ) ) \\ Re ( {x}^{( 1 )} ( i ) ) \\ Im ( {x}^{( 0 )} ( i ) ) \\ Im ( {x}^{( 1 )} ( i ) )\end{matrix} ]$$

where the precoding matrices W₁(i), W₂(i) corresponding to first and second CSI-RS resources, layer are of size P×υ and Q×υ respectively and i=0, 1, . . . M_{symb}^{ap}−1, M_{symb}^{ap}=M_{symb}^{layer}.

For spatial multiplexing, the values of W₁(i), W₂(i) shall be selected among the precoder elements in the codebook configured in the eNodeB and the UE. The eNodeB can further confine the precoder selection in the UE to a subset of the elements in the codebook using codebook subset restrictions. The configured codebook shall be selected from Table 6.3.4.2.3-1 or 6.3.4.2.3-2 of 36.211.

(End Definition)

In one method, the aggregated CQI is defined as follows based on transmit diversity scheme over two CSI-RS resources with per-CSI-RS resource precoding.

Aggregated CQI Definition Based on Transmit Diversity Scheme Over Two CSI-RS Resources

For aggregated CQI based on two CSI-RS resources with per CSI-RS resource precoding and inter-CSI-RS resource transmit diversity, if the UE is configured for PMI/RI reporting, the UE-specific reference signal overhead is consistent rank<=2 transmission; and PDSCH signals on antenna ports {7,8} for υ layers result in signals equivalent to corresponding symbols transmitted on antenna ports {a₁, a₂, . . . a_{P}} of a first CSI-RS resource, as given by:

$$[ \begin{matrix}{y}^{( a 1 )} ( 2 i ) \\ ⋮ \\ {y}^{( aP )} ( 2 i ) \\ {y}^{( a 1 )} ( 2 i + 1 ) \\ ⋮ \\ {y}^{( aP )} ( 2 i + 1 )\end{matrix} ] = [ \begin{matrix}{W}_{1} ( i ) & 0 & j {W}_{1} ( i ) & 0 \\ 0 & {W}_{1} ( i ) & 0 & j {W}_{1} ( i )\end{matrix} ] [ \begin{matrix}Re ( {x}^{( 0 )} ( i ) ) \\ Re ( {x}^{( 1 )} ( i ) ) \\ Im ( {x}^{( 0 )} ( i ) ) \\ Im ( {x}^{( 1 )} ( i ) )\end{matrix} ] ,$$

and result in signals transmitted on antennas ports {b₁, b₂, . . . b_{Q}} of a second CSI-RS resource, as given by:

$$[ \begin{matrix}{y}^{( b 1 )} ( 2 i ) \\ ⋮ \\ {y}^{( bQ )} ( 2 i ) \\ {y}^{( b 1 )} ( 2 i + 1 ) \\ ⋮ \\ {y}^{( b Q )} ( 2 i + 1 )\end{matrix} ] = [ \begin{matrix}0 & {W}_{2} ( i ) & 0 & j {W}_{2} ( i ) \\ {W}_{2} ( i ) & 0 & - j {W}_{2} ( i ) & 0\end{matrix} ] [ \begin{matrix}Re ( {x}^{( 0 )} ( i ) ) \\ Re ( {x}^{( 1 )} ( i ) ) \\ Im ( {x}^{( 0 )} ( i ) ) \\ Im ( {x}^{( 1 )} ( i ) )\end{matrix} ] ,$$

where x(i)=[x⁽⁰⁾(i) x⁽¹⁾(i)]^{T} is a vector of symbols from the layer mapping in section 6.3.3.2 of REF1, and P, Q E {1,2,4,8} are the number of CSI-RS ports configured for the first and second CSI-RS resources respectively. If only one CSI-RS port is configured for the first CSI-RS resource, W₁(i) is 1; otherwise W₁(i) is the precoding matrix corresponding to the reported PMI applicable to the first CSI-RS resource. If only one CSI-RS port is configured for the second CSI-RS resource, W₂ (i) is 1; otherwise W₂(i) is the precoding matrix corresponding to the reported PMI applicable to the second CSI-RS resource. The corresponding PDSCH signals transmitted on antenna ports {a₁, a₂, . . . a_{P}} and {b₁, b₂, . . . b_{Q}} have a ratio of EPRE to CSI-RS EPRE configured for the corresponding CSI-RS resource (i.e., the configured value of P_{c}, the assumed ratio of PDSCH EPRE to CSI-RS EPRE for the corresponding CSI-RS resource).

In one method, the above definition could be based on transmit diversity scheme using ports {7, 9}, in which case the overhead is consistent with rank>2 transmission (24 REs/Resource Block).

Aggregated CQI with Larger Set of Measurement TPs and Transmit Diversity

In an embodiment, an eNB may setup more than 2 TPs as a measurement set for a UE. In this case, two different transmit diversity schemes can be used for aggregated CQI definition at the UE: Transmit TP selection and transmit TP switching/hopping.

In transmit TP selection, a UE selects two out of N (>2) TPs in the measurement set and then performs the same operations as outlined in the Aggregated CQI with Wideband Phase Feedback embodiment (described above) using two selected TPs and corresponding PMI to derive the aggregated CQI. The transmit TP pair selection may be performed over the whole bandwidth. In one method, the transmit TP pair selection could be based on one or more of (i) the ranking of received powers from each TP; (ii) the ranking of per-TP CQIs; and (iii) the ranking of a resulting aggregated CQI with the selection. A UE may optionally feedback the selected TP indices to the network.

In transmit TP switching/hopping, the UE switches the TP set/pair assumed for transmission per resource or per subband. The switching can be predefined or based on per-TP measurements at the UE. This scheme is inferior to transmit TP selection and may not be preferred, though it may be considered in environments with similar signal strength from all TPs.

Aggregated CQI with Higher Rank JT Transmission, Precoding Per CSI-RS Resource and Large Delay CDD

In an embodiment, a large delay CDD (cyclic delay diversity) scheme can be determined for high rank JT transmission as follows:

$$[ \begin{matrix}{y}^{( {q}_{0} )} ( i ) \\ ⋮ \\ {y}^{( {q}_{P} )} ( i ) \\ {y}^{( {b}_{1} )} ( i ) \\ ⋮ \\ {y}^{( {b}_{Q} )} ( i )\end{matrix} ] = [ \begin{matrix}{W}_{1} ( i ) & 0 \\ 0 & {W}_{2} ( i )\end{matrix} ] A ( i ) [ \begin{matrix}{x}^{( 0 )} ( i ) \\ ⋮ \\ {x}^{( υ - 1 )} ( i )\end{matrix} ]$$

where A(i) are from a pre-determined set of precoding matrices of dimension υ×υ, which can be cycled per subband or RB or per set of subcarriers. For large delay CDD, A(i) can be defined as follows:

A(i)=w(i)D(i)U

where the precoding matrix w(i) is of size υ×υ, D(i) is a diagonal delay matrix, and U is a unitary matrix. An example is shown in Table 3 below (which is similar to Table 6.3.4.2.2-1 in REF1) for different total rank of transmission υ (rank>1).

TABLE 3
Examples of unitary matrix and diagonal delay matrix

| Num- | | |
|---|---|---|
| ber of | | |
| layers | | |
| υ | U | D(i) |
| 2 | $\frac{1}{\sqrt{2}} [ \begin{matrix}1 & 1 \\ 1 & {e}^{- j 2 π / 2}\end{matrix} ]$ | $[ \begin{matrix}1 & 0 \\ 0 & {e}^{- j 2 π i / 2}\end{matrix} ]$ |
| 3 | $\frac{1}{\sqrt{3}} [ \begin{matrix}1 & 1 & 1 \\ 1 & {e}^{- j 2 π / 3} & {e}^{- j 4 π / 3} \\ 1 & {e}^{- j 4 π / 3} & {e}^{- j 8 π / 3}\end{matrix} ]$ | $[ \begin{matrix}1 & 0 & 0 \\ 0 & {e}^{- j 2 π i / 3} & 0 \\ 0 & 0 & {e}^{- j 4 π i / 3}\end{matrix} ]$ |
| 4 | $\frac{1}{2} [ \begin{matrix}1 & 1 & 1 & 1 \\ 1 & {e}^{- j 2 π / 4} & {e}^{- j 4 π / 4} & {e}^{- j 6 π / 4} \\ 1 & {e}^{- j 4 π / 4} & {e}^{- j 8 π / 4} & {e}^{- j 12 π / 4} \\ 1 & {e}^{- j 6 π / 4} & {e}^{- j 12 π / 4} & {e}^{- j 18 π / 4}\end{matrix} ]$ | $[ \begin{matrix}1 & 0 & 0 & 0 \\ 0 & {e}^{- j 2 π i / 4} & 0 & 0 \\ 0 & 0 & {e}^{- j 4 π i / 4} & 0 \\ 0 & 0 & 0 & {e}^{- j 6 π i / 4}\end{matrix} ]$ |

In one method, w(i) is set to identity independent of rank υ of transmission.

In another method, w(i) is set to identity for υ=2. For υ=4, the UE may assume that the eNB cyclically assigns different precoders to different vectors [x⁽⁰⁾(i) . . . x^{(υ-1)}(i)]^{T} on the physical downlink shared channel according to W(i)=Cₖ, where k is the precoder index, kε{1,2,3,4} and C₁, C₂, C₃, C₄ denote precoder matrices corresponding to precoder indices 12, 13, 14 and 15, respectively, in Table 6.3.4.2.3-2 of REF1.

In yet another method, the precoder A(i) is fixed for subcarrier indices in a RB, and cycled across RBs, since the DMRS is used for demodulation and the precoding is fixed per RB.

In still another method, the υ DMRS ports capture the precoded channels based on W₁(i) and W₂(i) only, but the UE explicitly derives the overall precoding

$$[ \begin{matrix}{W}_{1} ( i ) & 0 \\ 0 & {W}_{2} ( i )\end{matrix} ] A ( i )$$

for demodulation from these DMRS ports (e.g., assuming cycling of A(i) as defined in REF1). This allows per subcarrier cycling of A(i). However the definition of a new large delay CDD mode based on DMRS (instead of CRS) is needed for this purpose.

In one method, the UE computes aggregated CQI based on the following steps:

1) Derive PMI F1 for TP1 based on channel measurement H1 to TP1.

2) Derive PMI F2 for TP2 based on channel measurement H2 to TP2.

3) Derive equivalent channels H1F1 and H2F2

4) Derive aggregated CQI assuming equivalent channels H1F1 and H2F2 and a CDD scheme.

The relevant part of CQI definitions in REF1 may be modified as follows.

For aggregated CQI based on two CSI-RS resources with per CSI-RS resource precoding and inter-CSI-RS resource large delay CDD, if the UE is configured for PMI/RI reporting, the UE-specific reference signal overhead is consistent with reported rank; and PDSCH signals on antenna ports {7, . . . 6+υ} for υ layers result in signals equivalent to corresponding symbols transmitted on antenna ports {a₁, a₂, . . . a_{P}} of a first CSI-RS resource and on antennas ports {b₁, b₂, . . . b_{Q} } of a second CSI-RS resource, as given by:

$$[ \begin{matrix}{y}^{( {q}_{0} )} ( i ) \\ ⋮ \\ {y}^{( {q}_{P} )} ( i ) \\ {y}^{( {b}_{1} )} ( i ) \\ ⋮ \\ {y}^{( {b}_{Q} )} ( i )\end{matrix} ] = [ \begin{matrix}{W}_{1} ( i ) & 0 \\ 0 & {W}_{2} ( i )\end{matrix} ] A ( i ) [ \begin{matrix}{x}^{( 0 )} ( i ) \\ ⋮ \\ {x}^{( υ - 1 )} ( i )\end{matrix} ] ,$$

where x(i)=[x⁽⁰⁾(i) x⁽¹⁾(i)]^{T} is a vector of symbols from the layer mapping in Section 6.3.3.2 of REF1, P,Qε{1,2,4,8} are the number of CSI-RS ports configured for the first and second CSI-RS resources respectively. If only one CSI-RS port is configured for the first CSI-RS resource, W₁(i) is 1, otherwise W₁(i) is the precoding matrix corresponding to the reported PMI applicable to the first CSI-RS resource. If only one CSI-RS port is configured for the second CSI-RS resource, W₂(i) is 1, otherwise W₂(i) is the precoding matrix corresponding to the reported PMI applicable to the second CSI-RS resource. The corresponding PDSCH signals transmitted on antenna ports {a₁, a₂, . . . a_{P}} and {b₁, b₂, . . . b_{Q}} have a ratio of EPRE to CSI-RS EPRE configured for the corresponding CSI-RS resource (i.e., the configured value of P_{c}, the assumed ratio of PDSCH EPRE to CSI-RS EPRE for the corresponding CSI-RS resource). A(i) is defined as described above.

Aggregated CQI with Higher Rank JT Transmission and CDD Transmit Diversity with No Precoding per CSI-RS Resource

In an embodiment, open loop spatial multiplexing based on large delay CDD is used for higher ranks with no per-CSI-RS resource precoding as follows:

$$[ \begin{matrix}{y}^{( {a}_{0} )} ( i ) \\ ⋮ \\ {y}^{( {a}_{P} )} ( i ) \\ {y}^{( {b}_{1} )} ( i ) \\ ⋮ \\ {y}^{( {b}_{Q} )} ( i )\end{matrix} ] = A ( i ) [ \begin{matrix}{x}^{( 0 )} ( i ) \\ ⋮ \\ {x}^{( υ - 1 )} ( i )\end{matrix} ]$$

where

A(i)=w(i)D(i)U

and where the precoding matrix w(i) is of size (P+Q)×υ, D(i) is a diagonal delay matrix, and U is a unitary matrix. An example is shown in Table 3 above for different total rank of transmission υ (rank>1).

For P=1 and P=Q, (i.e., P+Q=2), the precoder is selected according to W=C₁ where C₁ denotes the precoding matrix corresponding to precoder index 0 in Table 6.3.4.2.3-1 of REF1. For P=2 and P=Q (i.e., P+Q=4), the UE may assume that the eNB cyclically assigns different precoders to different vectors [x⁽⁰⁾(i) . . . x^{(υ-1)}(i)]^{T} on the physical downlink shared channel according to W(i)=Cₖ, where k is the precoder index, kε{1,2,3,4} and C₁, C₂, C₃, C₄ denote precoder matrices corresponding to precoder indices 12, 13, 14 and 15, respectively, in Table 6.3.4.2.3-2 of REF1.

The relevant part of CQI definitions in REF1 may be modified as follows.

For aggregated CQI based on two CSI-RS resources without CSI-RS resource precoding and inter-CSI-RS resource large delay CDD, if the UE is configured for PMI/RI reporting, the UE-specific reference signal overhead is consistent with reported rank; and PDSCH signals on antenna ports {7, . . . 6+υ} for υ layers result in signals equivalent to corresponding symbols transmitted on antenna ports {a₁, a₂, . . . a_{P}} of a first CSI-RS resource and on antennas ports {b₁, b₂, . . . b_{Q}} of a second CSI-RS resource as given by:

$$[ \begin{matrix}{y}^{( {a}_{0} )} ( i ) \\ ⋮ \\ {y}^{( {a}_{P} )} ( i ) \\ {y}^{( {b}_{1} )} ( i ) \\ ⋮ \\ {y}^{( {b}_{Q} )} ( i )\end{matrix} ] = A ( i ) [ \begin{matrix}{x}^{( 0 )} ( i ) \\ ⋮ \\ {x}^{( υ - 1 )} ( i )\end{matrix} ] ,$$

where x(i)=[x⁽⁰⁾(i) x⁽¹⁾(i)]^{T} is a vector of symbols from the layer mapping in section 6.3.3.2 of REF1, P, Qε{1,2,4,8} are the number of CSI-RS ports configured for the first and second CSI-RS resources respectively. The corresponding PDSCH signals transmitted on antenna ports {a₁, a₂, . . . a_{P}} and {b₁, b₂, . . . b_{Q}} have a ratio of EPRE to CSI-RS EPRE configured for the corresponding CSI-RS resource (i.e., the configured value of P_{c}, the assumed ratio of PDSCH EPRE to CSI-RS EPRE for the corresponding CSI-RS resource). A(i) is defined as described above.

In one method, the precoder A(i) is fixed for subcarrier indices in a RB, and cycled across RBs, since DMRS is used for demodulation and the precoding is fixed per RB. In another method, the unprecoded channels are transmitted on (P+Q) DMRS ports, and the UE explicitly derives the precoded channel, based on per subcarrier cycling of A(i) (e.g., as defined in REF1). A new large delay CDD transmission mode based on DMRS may be defined for this purpose.

Aggregated CQI with TP Cycling

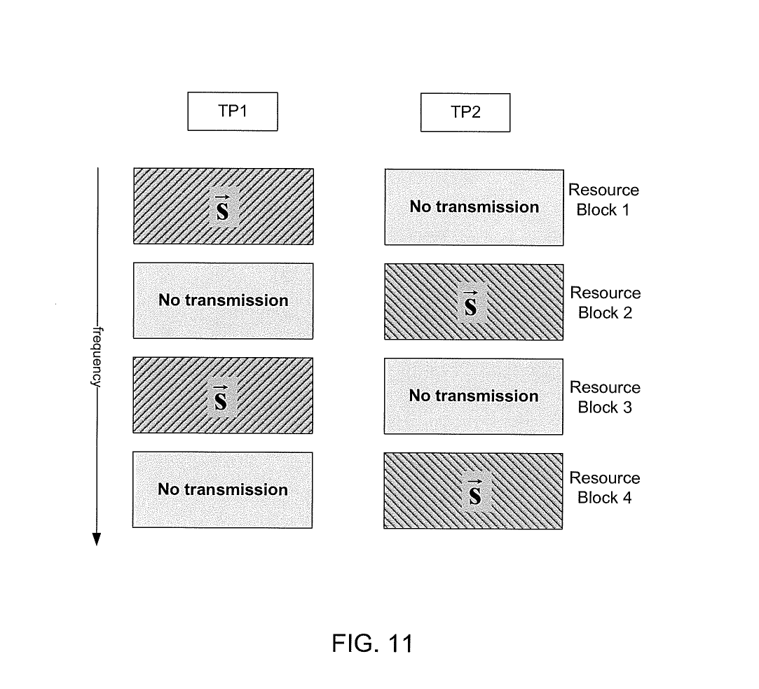

FIG. 11 illustrates an example definition of aggregated CQI with TP cycling, according to an embodiment of this disclosure. The embodiment illustrated in FIG. 11 is for illustration only. Other embodiments could be used without departing from the scope of this disclosure.

In FIG. 11, TP hopping and blanking can be used to obtain diversity. The set of spatial streams \vec{s} are transmitted by only one TP at a time. Due to hopping between the TPs in frequency, each TP can transmit at twice the power in its resources (with an equal split of resources). The hopping can be assumed to be at an RB level and can be performed transparently by the network, by mapping the appropriate channel to the DMRS port in each RB (TP 1 channel in RB1, TP2 channel in RB2 and so on.)

Any of the transmission schemes may be used at each of the individual TPs, including closed loop precoding, transmit diversity, and large delay CDD, as defined in REF1. However, a single rank is assumed for both TPs as the same set if spatial streams are transmitted on both TPs.

In one example with precoding, the transmitted signals can be written as follows.

$$[ \begin{matrix}{y}^{( {a}_{1} )} ( i ) \\ ⋮ \\ {y}^{( {a}_{p} )} ( i )\end{matrix} ] = {W}_{1} ( i ) [ \begin{matrix}{x}^{( 0 )} ( i ) \\ ⋮ \\ {x}^{( υ - 1 )} ( i )\end{matrix} ] , i ∈ {Ω}_{1} \\ = 0 otherwise$$

$$and$$

$$\begin{matrix}[ \begin{matrix}{y}^{( {b}_{1} )} ( i ) \\ ⋮ \\ {y}^{( {b}_{Q} )} ( i )\end{matrix} ] = {W}_{2} ( i ) [ \begin{matrix}{x}^{( 0 )} ( i ) \\ ⋮ \\ {x}^{( υ - 1 )} ( i )\end{matrix} ] , i ∈ {Ω}_{2} \\ = 0 otherwise\end{matrix}$$

where Ω₁, Ω₂ is the set of REs where antenna ports of CSI-RS resource 1 and 2 transmit respectively. In one example, the antenna ports of CSI-RS resource 1 transmit on even RBs, while the antenna ports of resource 2 transmit on odd RBs.

In another method, different sets of spatial streams may be transmitted from each TP. For example, codeword 1 can be transmitted from one TP and codeword 2 can be transmitted from the second TP. Such a scheme does not achieve diversity, but allows multiplexing spatial layers across TPs.

Aggregated CQI Based on Single Antenna Port from Each CSI-RS Resource

In an embodiment, an aggregated CQI is defined based on a single antenna port from each CSI-RS resource. In one method, only a single port may be configured in each CSI-RS resource. However, in other methods, these embodiments may be extended to a fixed number of antenna ports per CSI-RS resource (e.g., two per CSI-RS resource).

The aggregated CQI may be defined assuming a transmit diversity scheme (SFBC or STBC Alamouti scheme) based on the two antenna ports, one from each CSI-RS resource. The network may indicate a separate EPRE to CSI-RS port ratio Pc specifically for the purpose of computing aggregated CQI, e.g., to capture additional gain possible at the network by using more than one port per CSI-RS resource. In an embodiment, such aggregated CQI based on two antenna ports, one from each CSI-RS resource, is defined based on the precoding on the two antenna ports.

In an embodiment, aggregated CQI is defined based on more than two antenna ports, but with a single antenna port per CSI-RS resource. Again, such aggregated CQI could be based on a transmit diversity scheme or a precoding scheme. The single antenna port per CSI-RS resource, as described in the above embodiments, could be a fixed antenna port of the antenna ports corresponding to a CSI-RS resource (e.g., port 0 of the CSI-RS resource)

In an embodiment, aggregated CQI across two or more CSI-RS resources may be defined based on a single antenna port from each CSI-RS resource using any of the currently defined transmission schemes in section 6.3.4 of REF1, e.g., (i) transmit diversity, (ii) large delay CDD; or (iii) precoding without CDD. In an embodiment, when aggregated CQI is based on precoding on the corresponding single CSI-RS ports, one each from each CSI-RS resource, a corresponding aggregate PMI on the corresponding single CSI-RS ports, one each from each CSI-RS resource, may also be fed back.

Encoding Aggregated CQI

In embodiment, the sub-band aggregated CQI is encoded as a differential CQI with wideband aggregated CQI. Thus, the offset level is defined as:

Differential Aggregated CQI Index for Subband=Subband Aggregated CQI Index−Wideband Aggregated CQI Index

and is mapped to a differential CQI value/representation as shown in Table 4 below, which can be transmitted using 2 bits of information.

TABLE 4
Mapping of differential CQI value
(subband aggregate-wideband aggregate) to offset level

| Subband differential | |
|---|---|
| aggregate CQI value | Offset level |
| 0 | 0 |
| 1 | 1 |
| 2 | ≧2 |
| 3 | ≦−1 |

The values in Table 4 represent only one example. Any other specific differential mapping may be used. In another embodiment, the wideband aggregated CQI is encoded as a differential CQI with the largest of the two (or more) of the per-TP wideband CQIs, as in the following:

Differential Aggregated CQI Index for Wideband=Wideband Aggregated CQI Index−maxi {Wideband CQI Index of TP i}.

In one embodiment, only positive offset levels are encoded, as shown in Table 5 below, since aggregated CQI is always larger than the per-TP CQI.

TABLE 5
Mapping of differential CQI value (aggregate CQI-per TP CQI)
to set of +ve offset levels

| Wideband differential | |
|---|---|
| aggregate CQI value | Offset level |
| 0 | 0 |
| 1 | 1 |
| 2 | 2 |
| 3 | 4 |

In another embodiment, subband aggregated CQI is encoded as a differential CQI with the largest of the two (or more) of the per TP wideband CQIs, as in the following:

Differential Aggregated CQI Index for subband−Subband Aggregated CQI Index−maxᵢ {Wideband CQI Index of TP i}.

In other embodiments, the max operation over per-TP CQIs in the above definitions may be replaced by any of the (i) minimum, (ii) average, or (iii) sum operations.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use at a user equipment (UE) in a Coordinated Multipoint (CoMP) wireless network comprising a plurality of transmission points (TPs), a method of determining aggregated channel quality information (CQI), the method comprising:
receiving signals corresponding to a joint transmission from the plurality of TPs in the CoMP network;
making an assumption about a transmission scheme of the joint transmission from the TPs;
determining aggregated CQI corresponding to the joint transmission based on the assumption about the transmission scheme; and
transmitting the aggregated CQI to the network.

2. The method of claim 1, wherein the aggregated CQI is determined without an inter-TP phase component.

3. The method of claim 1, wherein the assumption includes that the joint transmission comprises a fixed inter-TP phase.

4. The method of claim 1, wherein the assumption includes that an inter-TP phase differs depending on a subband of the joint transmission, wherein a relationship between inter-TP phases and subbands is predetermined and known at the UE.

5. The method of claim 1, wherein the assumption includes transmit diversity of the joint transmission, in which a transmission from each TP is associated with a different precoded virtual channel.

6. The method of claim 5, wherein the number of TPs is greater than two, and the UE selects two of the TPs and determines the aggregated CQI based on the two selected TPs and the assumption of transmit diversity.

7. The method of claim 6, wherein the selection of the two TPs is based on at least one of: a ranking of received powers from each TP, a ranking of per-TP CQIs, and a ranking of a resulting aggregated CQI with the selection.

8. The method of claim 1, wherein the assumption includes TP hopping and blanking.

9. For use in a Coordinated Multipoint (CoMP) wireless network comprising a plurality of transmission points (TPs), a user equipment (UE) configured to determine aggregated channel quality information (CQI), the UE comprising:
processing circuitry configured to:
receive signals corresponding to a joint transmission from the plurality of TPs in the CoMP network;
make an assumption about a transmission scheme of the joint transmission from the TPs;
determine aggregated CQI corresponding to the joint transmission based on the assumption about the transmission scheme; and
transmit the aggregated CQI to the network.

10. The UE of claim 9, wherein the aggregated CQI is determined without an inter-TP phase component.

11. The UE of claim 9, wherein the assumption includes that the joint transmission comprises a fixed inter-TP phase.

12. The UE of claim 9, wherein the assumption includes that an inter-TP phase differs depending on a subband of the joint transmission, wherein a relationship between inter-TP phases and subbands is predetermined and known at the UE.

13. The UE of claim 9, wherein the assumption includes transmit diversity of the joint transmission, in which a transmission from each TP is associated with a different precoded virtual channel.

14. The UE of claim 13, wherein the number of TPs is greater than two, and the UE selects two of the TPs and determines the aggregated CQI based on the two selected TPs and the assumption of transmit diversity.

15. The UE of claim 14, wherein the selection of the two TPs is based on at least one of: a ranking of received powers from each TP, a ranking of per-TP CQIs, and a ranking of a resulting aggregated CQI with the selection.

16. The UE of claim 9, wherein the assumption includes TP hopping and blanking.

17. For use in a Coordinated Multipoint (CoMP) wireless network, an eNodeB configured to control a plurality of transmission points (TPs), the eNodeB comprising:
processing circuitry configured to:
coordinate a joint transmission from the plurality of TPs to a user equipment (UE) in communication with the plurality of TPs; and
receive from the UE aggregated channel quality information (CQI) corresponding to the joint transmission,
wherein the aggregated CQI is determined based on an assumption about a transmission scheme of the joint transmission.

18. The eNodeB of claim 17, wherein the aggregated CQI is determined without an inter-TP phase component.

19. The eNodeB of claim 17, wherein the assumption includes that the joint transmission comprises a fixed inter-TP phase.

20. The eNodeB of claim 17, wherein the assumption includes that an inter-TP phase differs depending on a subband of the joint transmission, wherein a relationship between inter-TP phases and subbands is predetermined and known at the UE.
